(19) United States
(12) Patent Application Publication
(10) Pub. No.: US 2022/0346105 A1
(43) Pub. Date: Oct. 27, 2022

(54) PREEMPTIVE RESERVATION OF COMMUNICATION RESOURCES

(71) Applicants: Amit KALHAN, San Diego, CA (US); Kyocera Corporation, Kyoto (JP)

(72) Inventor: Amit KALHAN, San Diego, CA (US)

(21) Appl. No.: 17/760,872

(22) PCT Filed: Sep. 22, 2020
(86) PCT No.: PCT/US2020/051923

§ 371 Date: Mar. 16, 2022

Related U.S. Application Data
(60) Provisional application No. 62/910,188, filed on Oct. 3, 2019.

(51) Int. Cl. H04W 72/10

(52) U.S. Cl. CPC H04W 72/10

(57) ABSTRACT

A first user equipment (UE) device preemptively reserves a communication resource where the communication resource had been previously reserved by a second UE device for transmission. In response to an indication that the communication resource has been released from the second UE device reservation, the first UE device transmits over the communication resource.

### CLAIM OF PRIORITY

The present application claims the benefit of priority to Provisional Application No. 62/910,188, entitled “Pre-emptive Resource Reservation in NR-V2V Communication Network”, docket number TPRO 00344 US, filed Oct. 3, 2019, assigned to the assignee hereof and hereby expressly incorporated by reference in its entirety.

### FIELD

This invention generally relates to wireless communications and more particularly to preemptive reservation of communication resources.

### BACKGROUND

Existing and proposed communication systems employ techniques for establishing ad hoc networks where communication devices autonomously select communication resources for data transmissions. With distributed scheduling, a communication device can reserve a communication resource occurring in the future by transmitting a message notifying neighboring communication devices of the reservation. The neighboring communication devices take the communication resource reservation into account when selecting communication resources for data transmission.

### SUMMARY

A first user equipment (UE) device preemptively reserves a communication resource where the communication resource had been previously reserved by a second UE device for transmission. In response to an indication that the communication resource has been released from the second UE device reservation, the first UE device transmits over the communication resource.

### BRIEF DESCRIPTION OF THE DRAWINGS

FIG. 1A is a block diagram of an example of a communication system including multiple user equipment (UE) devices where a reserved communication resource is released.

FIG. 1B is an illustration of an example of a transmission comparison of a transmission with preemptive reservation with a transmission without preemptive reservation.

FIG. 1C is an illustration of a transmission where a UE device with higher priority data preempts transmission by another UE device that had previously reserved a communication resource.

FIG. 2 is a block diagram of an example of a communication device suitable for use as each of the communication devices.

FIG. 3 is a block diagram of an example of a UE device suitable for use as each of the UE devices.

FIG. 4 is a flow chart of an example of a method of communication resource contention using preemptive reservation.

### DETAILED DESCRIPTION

As discussed above, ad hoc networks can be established where communication devices reserve communication resources for future transmissions. For example, the Rel-14 of the 3rd Generation Partnership Project (3GPP) communication specification addresses communication with vehicles in C-V2X (LTE rel-14 V2X) Mode 4 and New Radio (NR) V2X Mode 2 where a communication device selects time-slot/frequency sub-band resources autonomously for data transmissions. In Time Division Multiple Access (TDMA) based Vehicle Ad hoc Networks (VANETs) autonomous selection of time-slots for data transmissions causes collisions if two or more devices select the same time-slot for their transmission. In a distributed scheduling system, a communication device interested in transmitting data transmits a reservation signal at time t₀ indicating resources to be used for the data transmission at a future time (t₀+tₖ). The neighboring devices receive and decode the reservation signal before considering their own resource selection for data transmissions to avoid collisions. For the examples herein, a user equipment (UE) device preemptively reserves a communication resource that has been reserved by another UE device and uses the communication resource for transmission if the communication resource reservation by the other UE device is released before the transmission time.

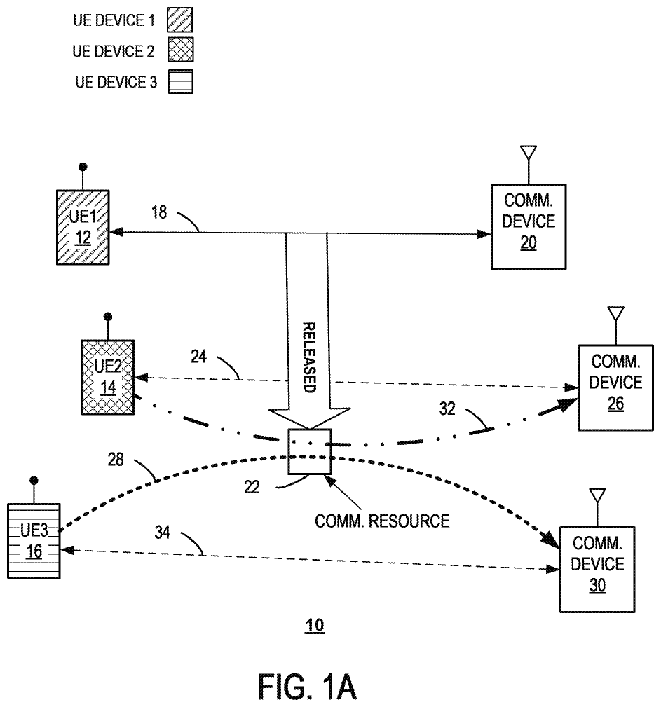

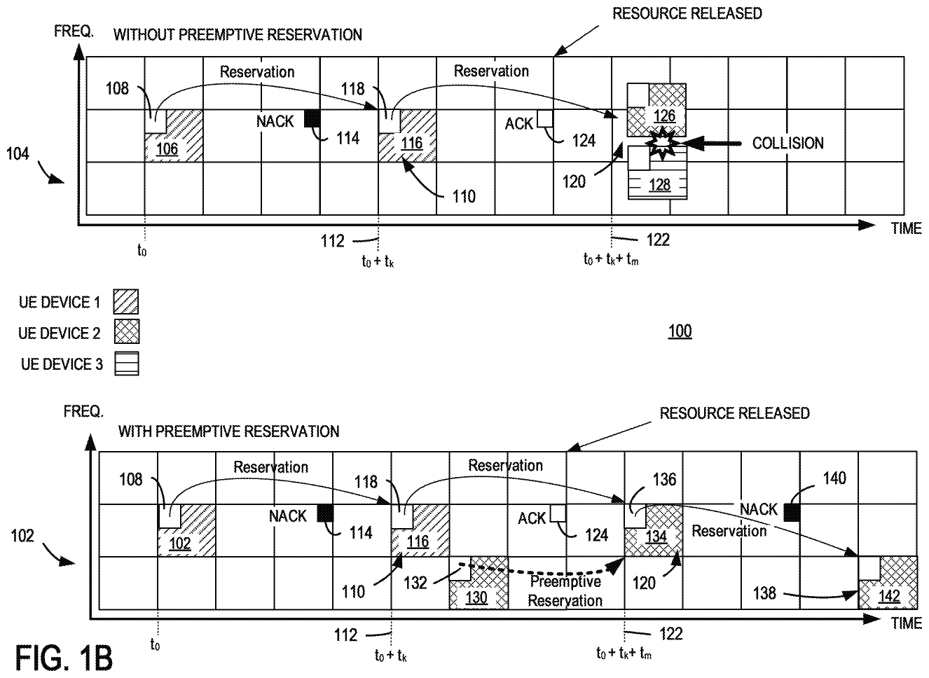

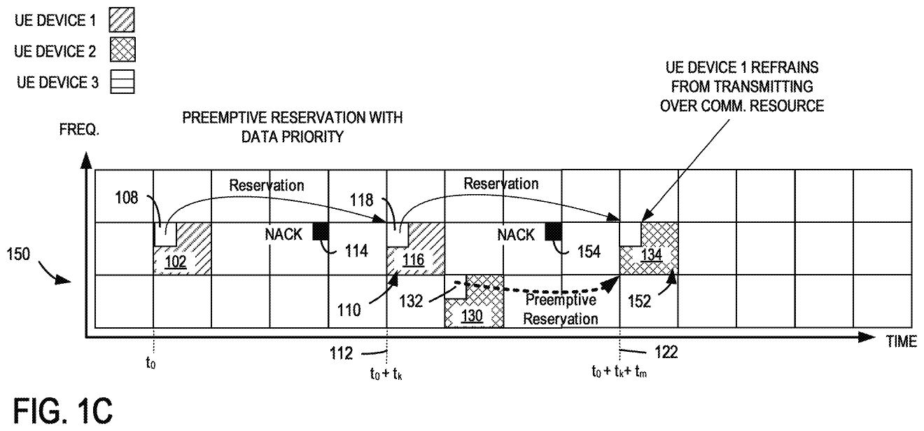

FIG. 1A is a block diagram of an example of a communication system 10 including multiple user equipment (UE) devices 12, 14, 16 where a reserved communication resource is released. Although the techniques discussed herein may be applied to various types of systems and communication specifications, the devices of the example operate in accordance with 3GPP New Radio (NR) V2X and LTE C2X (Rel-14)

For the example, three UE devices 12, 14, 16 are located in an area where the same communication resources are available to each UE device 12, 14, 16. The example begins with a first UE device (UE device 1) 12 in communication 18 with a first communication device 20. The communication device 20 may be any type of device that can receive signals from, and transmit signals to, the first UE device 12 and may be, for example, another UE device, a base station, access point, or transceiver station. During the communication 18, the first UE device 12 reserves communication resources such that other UE devices in the area do not transmit signal using the reserved communication resource. Continuing with the example, a reserved communication resource 22 is no longer needed for the communication 18 and the communication resource 22 is considered to be released allowing for other devices to use the communication resource 22. For the example, a second UE device (UE device 2) 14 is initiating, or engaged in, communication 24 with a second communication device 26 and a third UE device 14 is initiating, or engaged in, communication 28 with a third communication device 30. Each of the communication devices 26, 30 may be any type of device that can receive signals from, and transmit signals to, the first UE devices 14, 16 and may be, for example, another UE device, a base station, access point, or transceiver station. Although the communication devices 20, 26, 30 are shown as separate devices, two or more communication devices may be the same device in some circumstances. For example, the first communication device 20 and the second communication device 26 may the same device. In conventional systems, two or more UE devices may attempt to transmit on the newly released communication resource 22. For example, the second and third UE devices may transmit at the same time and at the same frequency resulting in a collision of the transmitted signals.

As discussed below in further detail, the techniques discussed herein avoid, or least reduce the chances of, two or more UE devices transmitting in the recently released communication resource 22 using a preemptive reservation. For the example of FIG. 1A, the second UE device 14 preemptively reserves the communication resource 22 after it has been reserved by the first UE device 12 but before the communication resource 22 is released. The third UE device 16 detects the preemptive reservation and does not transmit any signals using the released communication resource 22. As a result, the transmission 32 from the second UE device 14 does not collide with a transmission 34 from the third UE device 16 as would have occurred with conventional techniques.

FIG. 1B is an illustration of an example of a transmission comparison 100 of a transmission with preemptive reservation 102 with a transmission without preemptive reservation 104. The transmissions discussed with reference to FIG. 1B can be performed by the communication arrangement discussed above with reference to FIG. 1A. The transmission without preemptive reservation 104 results in a collision when two UE devices attempt to use the same communication resource that had been released from a reservation by a third UE device. For the example of FIG. 1, the available frequency spectrum is divided into frequency portions (sub-bands) and divided in time to create a plurality of frequency-time communication resources. Accordingly, each block of frequency and time is a communication resource as discussed herein. Multiple blocks can be used together to create a larger communication resource. The particular system may employ any number of communication resources and may use any of several different frequency portion lengths and time durations for the communication resource. For the examples herein the communication resources are in accordance with the 3GPP communication specification such as Rel-14 LTE C-V2X and Rel-16 NR V2X. For the example of the transmission 104, a reserving UE device (UE device 1) 12 transmits, at time to, a first signal 106 that includes data and a communication reservation indication 108 indicating that the reserving UE device is reserving a communication resource 120 at a future transmission time (t₀+tₖ) 112. The communication resource of FIG. 1B is an example of the communication resource 22 of FIG. 1A. The first signal 106 is part of communication 18 between the first UE device 12 and a communication device 20, such as another UE device, base station or radio transceiver. For the example, the reservation is a reservation for a HARQ-based transmission from the reserving UE device. If the first signal is not accurately received at the communication device 20, the communication device transmits a negative acknowledgement (NACK) signal. For the example, the NACK 114 is transmitted in response to the first signal 106. As a result, the first UE device 12, transmits a second signal 116 using the reserved communication resource 110. The second signal 116 includes data and a communication reservation indication 118 indicating that the reserving UE device is reserving a communication resource 120 at a future transmission time (t₀+tₖ+tₘ) 122. In response successful reception of the second signal 116, the communication device 20 transmits a positive acknowledgement (ACK) signal 124. The ACK signal 124 indicates to the UE devices in the area, such as second UE device (UE device 2) 14 and a third UE device (UE device 3) 16, that the communication resource 120 reserved by the first UE device 12 has been released. As a result, the second UE device 14 and the third UE device 16 transmit signals 126, 128 using the newly released communication resource 120. Although the second UE device 14 and third UE device 16 may attempt to reserve the communication resource 120 before transmission, the relatively short time between the ACK signal 124 and the transmission time 112 is inadequate for either UE device to determine the resource has been reserved. As a result, there is a collision between the signals 126, 128 and, typically, neither signal is accurately received by the intended recipients, such as the second communication device 26 and the third communication device 30.

In contrast, a collision is avoided in the transmission 102 with the preemptive reservation by a UE device. The transmission 102 example is similar to the example of the transmission 104 without the preemptive reservation except that the second UE device preemptively reserves the communication resource 120 released from the reservation by the first UE device 12. After detecting the reservation indicator 118 in the second signal 116, the second UE device transmits a signal 130 including a preemptive reservation indicator 132. The preemptive reservation indicator may be transmitted in either the SCI field of the control channel or as a message in the data channel transmission. Other UE devices in the area, such as the third UE device 16, receive the preemptive reservation indicator 132. After receiving the ACK signal 124, the second UE device 14 determines that communication resource 120 has been released from the reservation placed by the first UE device 12. The second UE device 14 transmits a signal 134 using the communication resource 120 that was preemptively reserved. The other UE devices in the area, such as the third UE device 16, receive the preemptive reservation indicator 118 and, in response, refrain from transmitting over the communication resource 120. As a result, a collision of signals is avoided. Continuing with the example, the signal 134 transmitted by the second UE device 14 includes a reservation indicator 136 indicating that another communication resource 138 is reserved. The intended recipient of the signal 134 transmits a NACK signal 140 indicating that the signal 134 was not successfully received. After receiving the NACK signal 140, the second UE device 14 transmits another signal 142 using the communication resource 138. Since the communication resource was reserved by the second UE device, no other UE device transmits using the communication resource 138.

In some situations, the released communication resource 120 may only be reserved for transmission of high priority data or packets. For example, rules or procedures may be in place such that a UE device must have high priority data to transmit over the communication resource before preemptively reserving the communication resource. In some cases, the newly released communication resource 120 may be used for a lower priority data transmission if it has not been preemptively reserved. In accordance with known techniques, data is designated in at least two priorities for such situations. Multiple priority levels may be used.

FIG. 1C is an illustration of a transmission 150 where a UE device with higher priority data preempts transmission by another UE device that had previously reserved a communication resource. In some situations, a higher priority data transmitting UE device uses a communication resource after preemptively reserving the communication resource that was reserved by a UE device having lower priority data to transmit where the lower priority data UE device refrains from using the communication resource. Referring to FIG. 1C for an example, the first UE device 12 reserves the communication resource 152 and the second UE device 14 preemptively reserves the communication resource 152 by transmitting a preemptive reservation indicator 132. For the example, the data to be transmitted by the second UE device 14 has a higher priority than the priority of the data to be transmitted by the first UE device 12 over the reserved communication resource 152. A NACK 154 is transmitted indicating that the previous transmission 116 from the first UE device 12 was not successfully received. For this example, however, the first UE device 12 refrains from transmitting on the communication resource 152 because of the relative priority of the data to be transmitted by the first UE device 12 and the second UE device 14. Therefore, the preemptive reservation 132 of the second UE device 14 results in the release of the communication resource 152. For the example, the priority levels of the data are assigned by the upper layers where the priority status (level) of the data is conveyed to the lower layers. Each UE device indicates the priority of the data in the side-link control information. Therefore, the second UE device determines the priority level of the first data from side-link control messages sent by the first UE device.

Accordingly, for the example, the first UE device 12 is configured to transmit a reservation indicator 118 to reserve the communication resource 152 for a transmission from the first UE device 12 of first data having the first priority level. The second UE device is configured to determine, at least partially based on the first priority level and the second priority level, whether to use the communication resource for transmission of the second data having the second priority level. The second device is further configured to transmits the preemptive reservation indicator if the second UE device determines the communication resource can be used for the transmission of the second data. The preemptive reservation indicator preemptively reserves the communication resource for transmission of the second data. The second UE device is configured to then transmit the second data using the communication resource.

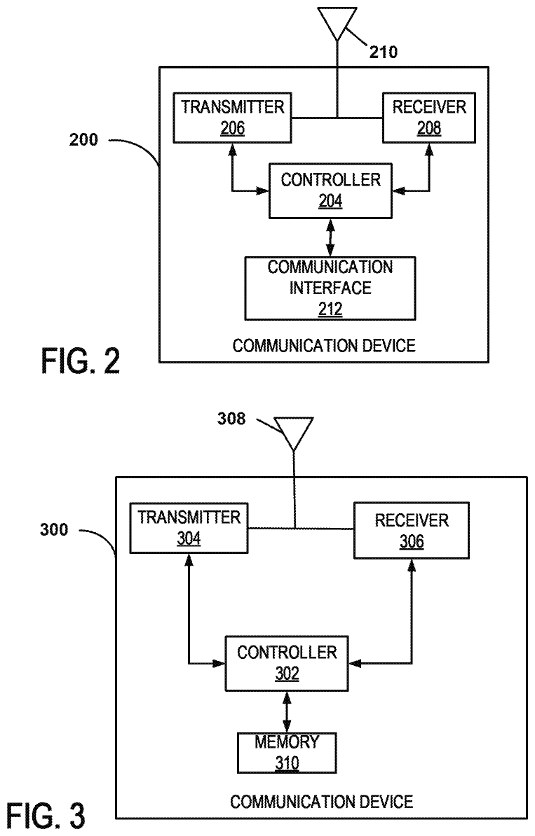

FIG. 2 is a block diagram of an example of a communication device 200 suitable for use as each of the communication devices 20, 26, 30. The communication device 200 includes a controller 204, transmitter 206, and receiver 208, as well as other electronics, hardware, and code. The communication device 200 is any fixed, mobile, or portable equipment that performs the functions described herein. The various functions and operations of the blocks described with reference to the communication devices 20, 26, 30, 200 may be implemented in any number of devices, circuits, or elements. Two or more of the functional blocks may be integrated in a single device, and the functions described as performed in any single device may be implemented over several devices. The communication device 200 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP NR operation. In some situations, the communication device 200 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the communication device 200 may be a portable device that is not fixed to any particular location. As discussed above, the communication device 200 may be a UE device is some circumstances.

The controller 204 includes any combination of hardware, software, and/or firmware for executing the functions described herein as well as facilitating the overall functionality of the communication device 200. An example of a suitable controller 204 includes code running on a microprocessor or processor arrangement connected to memory. The transmitter 206 includes electronics configured to transmit wireless signals. In some situations, the transmitter 206 may include multiple transmitters. The receiver 208 includes electronics configured to receive wireless signals. In some situations, the receiver 208 may include multiple receivers. The receiver 208 and transmitter 206 receive and transmit signals, respectively, through an antenna 210. The antenna 210 may include separate transmit and receive antennas. In some circumstances, the antenna 210 may include multiple transmit and receive antennas.

The transmitter 206 and receiver 208 in the example of FIG. 2 perform radio frequency (RF) processing including modulation and demodulation. The receiver 208, therefore, may include components such as low noise amplifiers (LNAs) and filters. The transmitter 206 may include filters and amplifiers. Other components may include isolators, matching circuits, and other RF components. These components in combination or cooperation with other components perform the communication device functions. The required components may depend on the particular functionality required by the communication device.

The transmitter 206 includes a modulator (not shown), and the receiver 208 includes a demodulator (not shown). The modulator modulates the signals to be transmitted as part of the downlink signals and can apply any one of a plurality of modulation orders. The demodulator demodulates any uplink signals received at the communication device 200 in accordance with one of a plurality of modulation orders.

Where the communication device is a base station, the communication device 200 includes a communication interface 212 for transmitting and receiving messages with other base stations. The communication interface 212 may be connected to a backhaul or network enabling communication with other base stations. In some situations, the link between base stations may include at least some wireless portions. The communication interface 212, therefore, may include wireless communication functionality and may utilize some of the components of the transmitter 206 and/or receiver 208.

The communication device 200 has the capability to observe one or more channels to determine if the channel is currently occupied. In other words, the communication device 200 can determine whether other devices are transmitting within the channel. For the examples herein, the receiver 208 detects energy within the channel and the controller makes a determination of whether the measured energy indicates the channel is in use. For example, the measured energy can be compared to a threshold. Other techniques can be used in some circumstances.

FIG. 3 is a block diagram of an example of a UE device 300 suitable for use as each of the UE devices 12, 14, 16. In some examples, the UE device 300 is any wireless communication device such as a mobile phone, a transceiver modem, a personal digital assistant (PDA), a tablet, or a smartphone. In other examples, the UE device 300 is a machine type communication (MTC) communication device or Internet-of-Things (IOT) device. The UE device 300, (106-109), therefore is any fixed, mobile, or portable equipment that performs the functions described herein. The various functions and operations of the blocks described with reference to UE device 300 may be implemented in any number of devices, circuits, or elements. Two or more of the functional blocks may be integrated in a single device, and the functions described as performed in any single device may be implemented over several devices.

The UE device 300 includes at least a controller 302, a transmitter 304 and a receiver 306. The controller 302 includes any combination of hardware, software, and/or firmware for executing the functions described herein as well as facilitating the overall functionality of a communication device. An example of a suitable controller 302 includes code running on a microprocessor or processor arrangement connected to memory. The transmitter 304 includes electronics configured to transmit wireless signals. In some situations, the transmitter 304 may include multiple transmitters. The receiver 306 includes electronics configured to receive wireless signals. In some situations, the receiver 306 may include multiple receivers. The receiver 304 and transmitter 306 receive and transmit signals, respectively, through antenna 308. The antenna 308 may include separate transmit and receive antennas. In some circumstances, the antenna 308 may include multiple transmit and receive antennas.

The transmitter 304 and receiver 306 in the example of FIG. 3 perform radio frequency (RF) processing including modulation and demodulation. The receiver 304, therefore, may include components such as low noise amplifiers (LNAs) and filters. The transmitter 306 may include filters and amplifiers. Other components may include isolators, matching circuits, and other RF components. These components in combination or cooperation with other components perform the communication device functions. The required components may depend on the particular functionality required by the communication device.

The transmitter 306 includes a modulator (not shown), and the receiver 304 includes a demodulator (not shown). The modulator can apply any one of a plurality of modulation orders to modulate the signals to be transmitted as part of the uplink signals. The demodulator demodulates the downlink signals in accordance with one of a plurality of modulation orders.

The UE device 300 has the capability to observe one or more uplink channels to determine if the channel is currently occupied. In other words, the UE device 300 can determine whether other devices are transmitting within the channel. For the examples herein, the receiver 304 detects energy within the channel and the controller makes a determination of whether the measured energy indicates the channel is in use. For example, the measured energy can be compared to a threshold. Other techniques can be used in some circumstances.

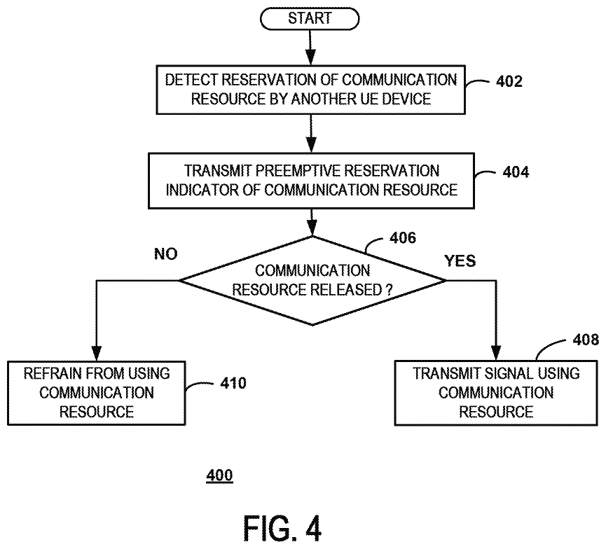

FIG. 4 is a flow chart of an example of a method of communication resource contention using preemptive reservation. The method may be performed by any device transmitting in the frequency band. For the example, the method is performed by a UE device operating in a NR V2X or LTE C-V2X system such as the system 10 described above. Accordingly, the method may be performed by the UE device 14.

At step 402, a communication resource reservation by another UE device is detected. For the example, the other device transmits reservation indicator to reserve the communication resource for a HARQ-based data transmission.

At step 404, a preemptive reservation indicator is transmitted. The preemptive reservation indicator indicates that the same communication resource reserved for the HARQ-based transmission is being preemptively reserved. The preemptive reservation indicator may be transmitted in either the SCI field of the control channel or as a message in the data channel transmission.

At step 406, it is determined whether the communication resource has been released. For the example, the UE determines whether a positive acknowledgement (ACK) has been transmitted to the other device in response to a successfully receive transmission from the other device. The device receiving the transmission from the other device may respond with an ACK or a negative acknowledgment (NACK) when the transmission is not successfully received. If an ACK is detected at step 406, it is determined that the communication resource has been released. If no ACK is detected or if a negative acknowledgment (NACK) is detected, it is determined that the communication resource has not been released. If it is determined that the communication resource has been released, the method proceeds to step 408 where a signal is transmitted using the preemptively reserved communication resource. Otherwise, the method continues at step 410 where the communication resource is not used for transmission.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1-25. (canceled)

26. A method comprising:
receiving, at a first user equipment (UE) device from a second UE device, a first indicator indicating that a communication resource is reserved for a first data transmission from the second UE device, the first data having a first priority;
determining, at the first UE device, whether the communication resource is also reserved for a second data transmission having a second priority, the second priority being higher than the first priority; and
in response to the determining, transmitting, from the first UE device to the second UE device, a second indicator indicating a conflict of the communication resource.

27. The method according to claim 26, further comprising:
in response to receiving the second indicator, refraining, at the second UE device, from transmitting the first data using the communication resource.

28. A first user equipment (UE) device comprising:
a receiver configured to receive, from a second UE device, a first indicator indicating that a communication resource is reserved for a first data transmission from the second UE device, the first data having a first priority;
a controller configured to determine whether the communication resource is also reserved for a second data transmission having a second priority, the second priority being higher than the first priority; and
a transmitter configured to, in response to the determining, transmit, to the second UE device, a second indicator indicating a conflict of the communication resource.

29. The first UE device according to claim 28, wherein,
the second indicator is to cause the second UE device to refrain from transmitting the first data using the communication resource.

30. An apparatus for controlling a first user equipment (UE) device, the apparatus comprising a processor and a memory, the processor is configured to:
receive, from a second UE device, a first indicator indicating that a communication resource is reserved for a first data transmission from the second UE device, the first data having a first priority;
determine whether the communication resource is also reserved for a second data transmission having a second priority, the second priority being higher than the first priority; and
in response to the determining, transmit, to the second UE device, a second indicator indicating a conflict of the communication resource.

31. The apparatus according to claim 30, wherein,
the second indicator is to cause the second UE device to refrain from transmitting the first data using the communication resource.
